(19) United States
(12) Patent Application Publication
(10) Pub. No.: US 2004/0251567 A1
(43) Pub. Date: Dec. 16, 2004

(54) Method and system for producing plastic optical fiber

(76) Inventors: Pierluigi Cappellini, Jersey Shore, PA (US); Hassan Bodaghi, Alpharetta, GA (US); James F. Peterson II, State College, PA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/461,122

(22) Filed: Jun. 13, 2003

(51) Int. Cl. B29D 11/00

(52) U.S. Cl. 264/1.29; 425/131.1

(57) ABSTRACT

A method and system are described for continuously producing plastic optical fiber. The method involves melting a polymeric starting material in a continuous screw extruder and then extruding the melted polymer vertically upward (i.e., against the force of gravity) to form a plastic optical fiber with a uniform core cross section.

### FIELD OF INVENTION

The present invention relates to plastic optical fibers. More particularly, the present invention concerns a method and system for continuously producing plastic optical fibers with uniform core cross sections.

### BACKGROUND OF INVENTION

Plastic optical fiber (POF) offers many potential advantages as a transmission medium in short-distance, high-speed networks. Compared to traditional copper wiring, POF can handle higher data rates and is not vulnerable to electromagnetic interference. Compared to glass optical fiber, POF is easier to install, connect, and maintain because POF is more flexible and has a larger core size. In addition, POF is potentially the cheapest transmission medium for these networks.

Consequently, considerable effort has been spent trying to develop low-cost methods and systems for making POF with low transmission losses. For example, U.S. Pat. No. 5,827,611 describes a process for making POF by:

(a) extruding [i.e., forming or shaping by forcing through an opening] a hollow tube from a preform;

(b) filling the hollow tube with a core admixture; and

(c) simultaneously heating and drawing [i.e., stretching] the filled tube to a suitable dimension.

One drawback of the process described in U.S. Pat. No. 5,827,611 is that it is a batch process. U.S. Pat. No. 5,827,611 characterizes its process as “continuous,” but this is a misnomer because preform-based processing is inherently a batch process; when the preform is used up, processing stops and a new preform must be installed. Most POF processing methods developed to date share this drawback because they are preform-based. To reduce costs and increase POF uniformity, it would be desirable to develop a truly continuous process for making POF. (Of course, even a continuous process may need to be stopped occasionally, e.g., for cleaning and maintenance.)

Numerous prior art patents, including U.S. Pat. No. 5,827,611, describe processing methods and systems that attempt to reduce transmission losses in POF. These losses can be caused by both intrinsic and extrinsic factors. Intrinsic factors include absorption by C—H vibrations and Rayleigh scattering. Extrinsic factors include absorption by transition metals and organic contaminants, as well as scattering by dust and microvoids, fluctuations in core diameter, orientational birefringence, and core-cladding boundary imperfections. There is an ongoing need to develop methods and systems that reduce one or more of these various loss factors.

One key processing variable that has not been recognized or controlled in the prior art is the direction in which the POF core is extruded. To our knowledge, all previous POF processing methods have extruded the POF core either vertically downward (i.e., with the force of gravity) or horizontally. Surprisingly, we have discovered that extruding POF vertically upward (i.e., against the force of gravity) enables POF with much less fluctuation in core diameter to be produced.

This improvement in core diameter uniformity for POF is even more surprising in view of U.S. Pat. No. 4,399,084, which uses “upward spinning” to produce a “fibrous assembly” for textile applications. As noted at column 16, lines 20-24, this patent describes using vertically upward extrusion to create nonuniform, irregular textile fibers:

“A further feature of this invention is that the filament has a non-circular cross section irregularly varying in size at irregular intervals along its longitudinal direction, and incident to this, the shape of its cross section also varies.”

Thus, the prior use of vertically upward extrusion to make irregular textile fibers does not teach or suggest the use of vertically upward extrusion to make uniform POF cores.

In addition, by combining vertically upward extrusion with continuous processing methods, such as screw extrusion, the present invention enables the continuous production of POF with uniform core cross section.

### SUMMARY OF THE INVENTION

The present invention overcomes the limitations and disadvantages of the prior art by providing a method and system for continuously making POF with uniform core cross section.

One aspect of the invention involves a method in which starting material is melted in a continuous screw extruder and then extruded vertically upward (i.e., against the force of gravity) to form a POF core with uniform cross section.

Another aspect of the invention involves a system that includes one or more screw extruders and one or more extrusion blocks. The one or more screw extruders are used to continuously melt starting material(s). The one or more extrusion blocks are then used to extrude the melted starting material(s) in a vertically upward direction to form POF core with uniform cross section.

Although continuous extrusion methods and vertically upward extrusion are both known in the area of textile fiber production, the combination of these two components to create POF with a uniform core cross section is not known or suggested by the textile fiber prior art. Indeed, the textile fiber prior art teaches away from vertically upward extrusion as used in the present invention.

For example, as discussed in the Background, the prior textile fiber art teaches away from the present invention by using “upward spinning” to produce “filament [that] has a non-circular cross section irregularly varying in size at irregular intervals along its longitudinal direction.” These prior teachings concerning textile fibers are diametrically opposed to the present invention, which teaches how to use vertically upward extrusion to create POF with uniform core cross section. The uniform core cross section will typically be a circular cross section, but other shapes can also be made (e.g., an elliptical, triangular, rectangular, or hexagonal cross section).

The foregoing and other embodiments and aspects of the present invention will become apparent to those skilled in the art in view of the subsequent detailed description of the invention taken together with the appended claims and the accompanying figures.

### DESCRIPTION OF DRAWINGS

FIG. 1 is a schematic diagram illustrating an exemplary system for continuously producing POF with uniform core cross section.

FIG. 2 is a schematic diagram illustrating the system of FIG. 1 with additional components for applying the POF cladding layer, measuring the POF uniformity, and winding the POF onto a spool.

FIG. 3 is a schematic diagram illustrating an alternative system for continuously producing POF with core and cladding.

FIG. 4 is a schematic diagram illustrating spin pack assembly 950 in more detail.

FIG. 5 is a schematic diagram illustrating multi-purpose block 350 and one half of transfer/heating block 400 in more detail.

FIG. 6 is a flow chart of an exemplary process for continuously producing POF with uniform core cross section using vertically upward extrusion.

### DETAILED DESCRIPTION

A method and system are described for continuously producing POF with uniform core cross section. In the following description, numerous specific details are set forth to provide a thorough understanding of the present invention. However, it will be apparent to one of ordinary skill in the art that the invention may be practiced without these particular details.

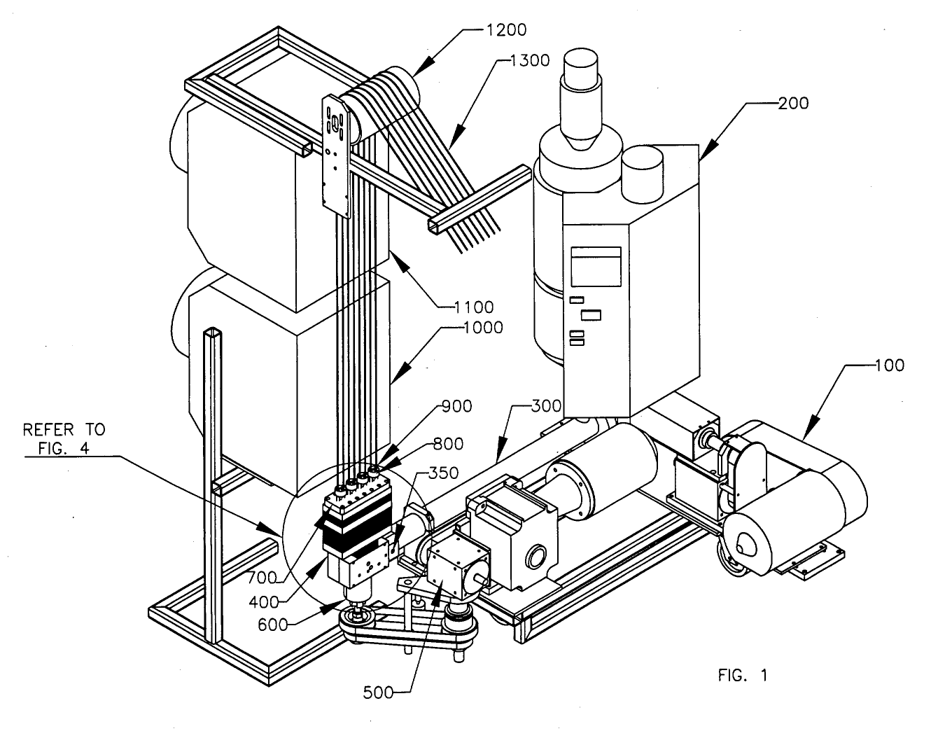

FIG. 1 illustrates an exemplary system for continuously producing POF with uniform core cross section. This exemplary system includes: extruder drive assembly 100, feed hopper/dryer system 200, screw/barrel assembly 300, multi-purpose block 350, transfer/heating block 400, pump/drive assembly 500, planetary gear pump 600, spinneret face plate 700, spinneret tips (or “pins”) 800, spinneret tip heaters 900, stage 1 quench unit 1000, stage 2 quench unit 1100, and first drive roll 1200.

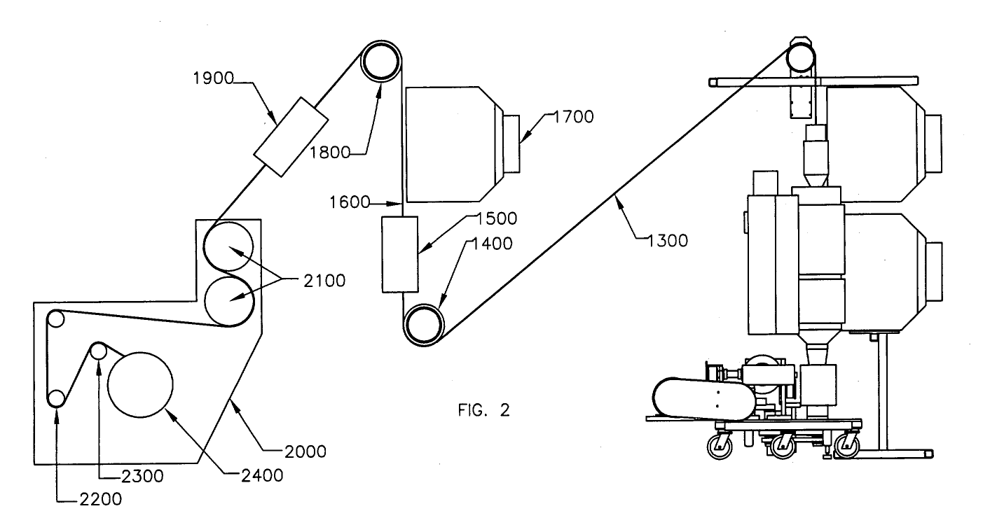

FIG. 2 illustrates the system of FIG. 1 with additional components for applying the POF cladding layer, measuring the POF uniformity, and winding the POF onto a spool. The additional components include: grooved roll 1400, crosshead extruder 1500, quench unit 1700, turning roll 1800, laser micrometer 1900, and winding unit 2000. Winding unit 2000 includes electrically driven rolls 2100, tension arm 2200, traverse mechanism 2300, and POF spool 2400.

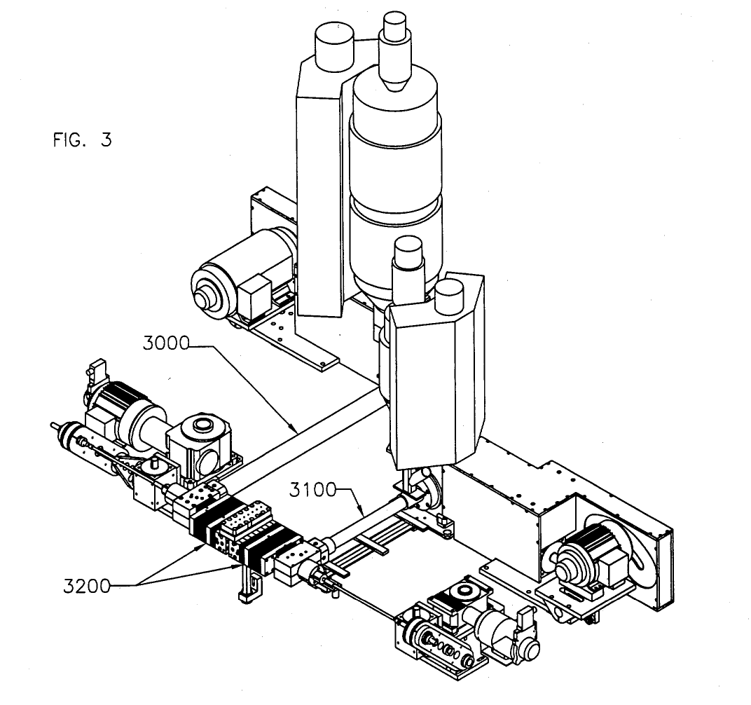

FIG. 3 illustrates an alternative system for continuously producing POF with core and cladding. Instead of using a POF core extruder and a separate POF cladding extruder 1500, the two extruders can be more tightly integrated in a multilayer extrusion system with a multisection block 3200. A first extruder 3000 supplies resin for the core of the POF. A second extruder 3100 supplies resin for the cladding. Each extruder can independently control the pressure and temperature for its POF material. Thus, the temperature and pressure of the POF cladding material can be maintained at a separate temperature and pressure from the POF core material until the cladding material is applied to the core in multi-section block 3200. This system provides for continuous in-line production of both POF core and POF cladding in one extrusion block.

For simplicity, FIG. 3 shows multi-section block 3200 with one extruder for the POF core and another extruder for the POF cladding. However, it will be understood by those of skill in the art that the multi-section block could be connected with additional extruders to produce multilayered POF core and/or multilayered POF cladding. For example, to make graded-index POF, multi-section block 3200 could be connected with additional extruders to produce multilayered POF core with radially varying properties (e.g., refractive index).

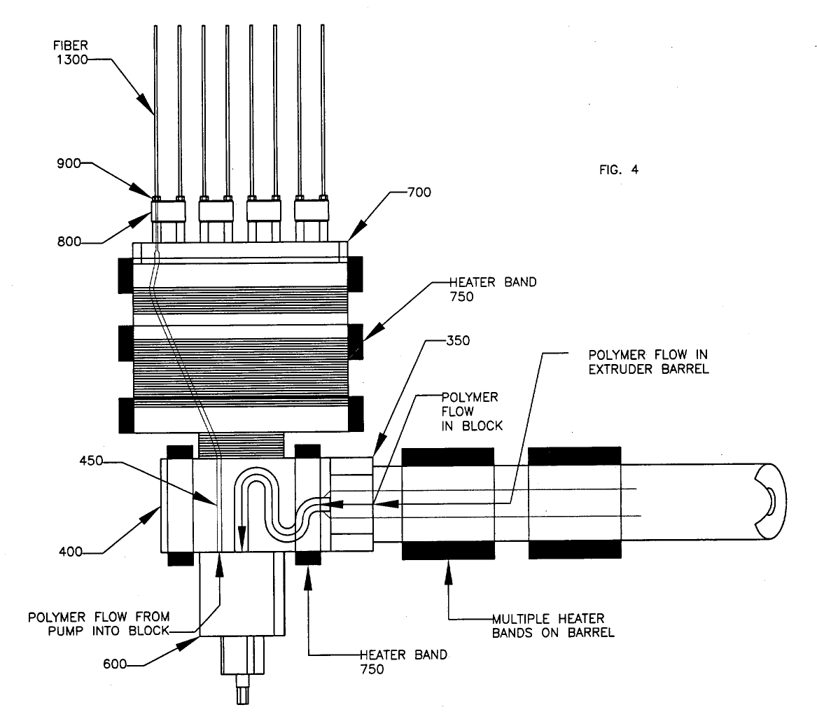

FIG. 4 illustrates spin pack assembly 950 in more detail. Spin pack assembly 950 includes multi-purpose block 350, transfer/heating block 400, spinneret face plate 700, heater bands 750, spinneret tips (or “pins”) 800, and spinneret tip heaters 900.

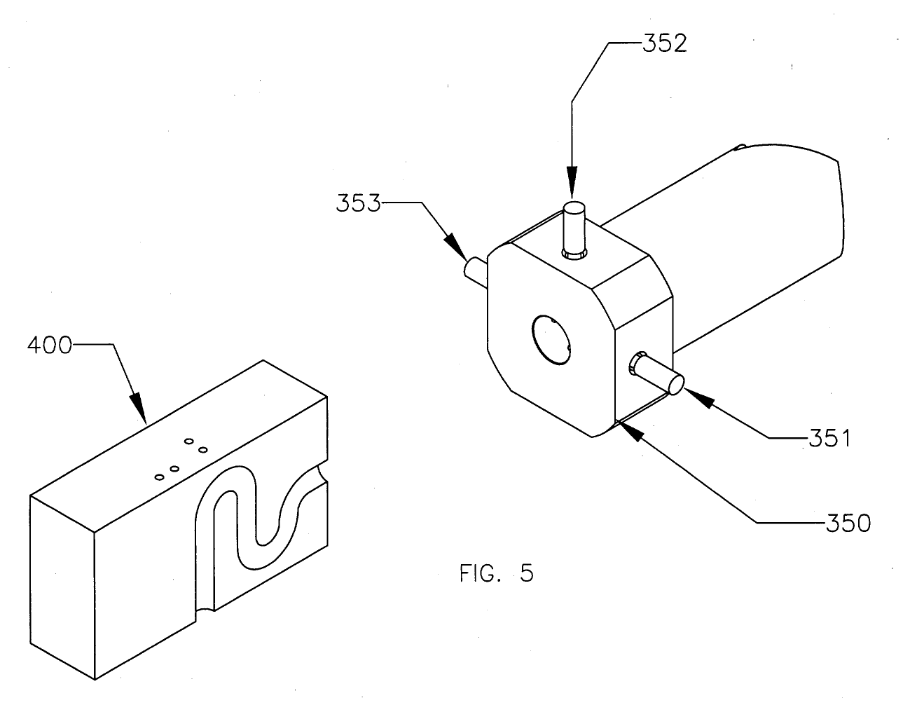

FIG. 5 illustrates multi-purpose block 350 and one half of transfer/heating block 400 in more detail. Multi-purpose block 350 includes burst plug 351 (a pressure safety valve), temperature probe 352, and pressure transducer 353. The design of blocks 350 and 400 minimizes resistance to polymer flow and provides feedback on processing parameters (i.e., temperature and pressure). As shown in FIG. 5, block 400 can be split into two halves for easier cleaning. Transfer block 400 also includes a breaker plate (not shown in FIG. 5) to improve mixing of the melted polymer.

The method described herein can be applied to virtually all POF core and cladding materials.

One exemplary POF core material is poly methyl methacrylate (PMMA). ATOFINA Chemicals, Inc. (900 First Avenue, King of Prussia, Pa. 19406) makes a PMMA resin designated “V825NA” that is a preferred core starting material because it has a high refractive index (1.49) and exhibits small transmission loss in the visible light region. Resins with higher melt flow rates, such as ATOFINA resin VLD-100, may also be used.

Other exemplary POF core materials include polystyrene, polycarbonate, copolymers of polyester and polycarbonate, and other amorphous polymers. In addition, semi-crystalline polyolefins, such as high molecular weight polypropylene and high-density, high molecular weight polyethylene can be used.

Exemplary POF cladding materials include fluorinated polymers such as polyvinylidene fluoride, polytetrafluoethylene hexafluoro propylene vinylidene fluoride, and other fluoroalkyl methacrylate monomer based resins. The cladding material must have a refractive index lower than that of the core polymer. Dyneon LLC (6744 33^{rd} Street North, Oakdale, Minn. 55128) fluorothermoplastics THV220G and THV220A and ATOFINA KYNAR Superflex 2500® have refractive indices between 1.35 and 1.41, which are lower than the refractive index of ATOFINA resin V825NA.

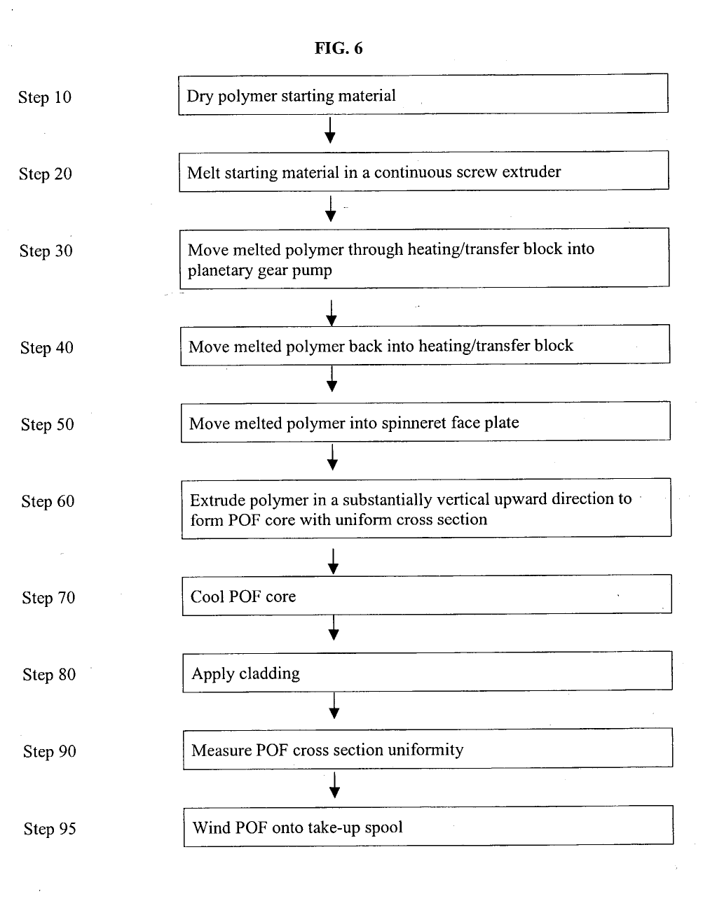

FIG. 6 is a flow chart illustrating an exemplary process for continuously producing plastic optical fibers with uniform core cross sections.

At step 10, pellets of clean and purified POF core polymer resin (polymeric starting material, typically supplied by a commercial resin manufacturer) are fed into feed hopper/dryer system 200. Dryer system 200 continually dries the core polymer resin using compressed air. The temperature used in dryer system 200 is typically between 80 and 100° C., with 90° C. being preferred. Moisture is removed from the resin by operating dryer system 200 at a dew point of −40° C. Dryer system 200 also has two coalescing filters in series to remove liquid water and oil droplet particles down to 0.01 micron in size. An exemplary dryer system 200 is a Novatec™ Compressed Air Dryer (Novatec, Inc. 222 E. Thomas Ave., Baltimore Md. 21225, www.novatec.com).

At step 20, extruder drive assembly 100 feeds the dried polymer into extruder screw/barrel assembly 300, where the dried polymer is melted. Extruder drive assembly 100 is a dedicated drive system that maintains a consistent operating RPM to provide stable pressure during the continuous extrusion process.

The gear ratio of the pulleys in extruder drive assembly 100 can be changed to enable the drive assembly motor to run at a preferred rate of 90-100% of the rated motor speed. A stable motor speed produces a stable screw speed, which, in turn, produces a consistent extrudate pressure. The measured pressure fluctuations are less than 2% during operation at various working pressures. Thus, the precision drive in extruder drive assembly 100 enables greater extruder control and feeding uniformity of the extrudate.

Extruder screw/barrel assembly 300 may be vented to remove volatile contaminants from the melted resin.

At step 30, the feed screw in extruder screw/barrel assembly 300 moves the melted polymer through multipurpose block 350 and transfer/heating block 400 into planetary gear pump 600 in a continuous, uniform manner. Planetary gear pump 600 is driven by dedicated drive assembly 500. Pump 600 is a single inlet pump with multiple outlets.

At step 40, the melted polymer moves back into transfer/heating block 400 in a continuous, uniform manner. Pump 600 pressurizes the molten polymer as it divides and distributes the flow into independent channels in transfer block 400. For clarity, only one of the independent channels (i.e., channel 450) in transfer block 400 is shown in FIG. 4.

Channel 450 in block 400 permits a high polymer flow rate with low restriction, thereby reducing shear heating (and concurrent temperature nonuniformities) in the polymer melt. The direction of polymer flow in spin pack assembly 950 can be changed in 90° increments. Thus, extrusion via spin pack assembly 950 can be vertically upward, vertically downward or horizontal. Heating bands 750 facilitate temperature control (and thus viscosity control) of the molten polymer while passing through spin pack assembly 950.

At step 50, the pressurized streams of molten polymer enter spinneret face plate 700, which is equipped with a set of threaded spinneret pins 800. Spinneret pins 800 are threaded for easy removal, thereby enabling rapid changeover in spinneret hole diameter as well as the pin length-to-diameter ratio. Spinneret tip heaters 900 control the temperature of the extrudate in spinneret pins 800. Such control enhances surface uniformity of the extrudate as it exits spinneret pins 800 and forms POF cores 1300. The temperature of spinneret pins 800 is preferably between 225 and 300° C. In an alternative embodiment, spinneret face plate 700 can include fixed, rather than threaded, spinneret pins 800.

At step 60, the molten polymer is extruded through spinneret pins 800 in a substantially vertical upward direction. Forcing the molten polymer through circular openings in spinneret pins 800 forms POF cores 1300 with uniform circular cross sections. Changing the shape of the openings in spinneret pins 800 can form POFs with other types of uniform cross sections. For example, forcing the molten polymer through elliptical openings in spinneret pins 800 forms POF cores 1300 with uniform elliptical cross sections. To increase the uniformity of the POF core cross sections, the extrusion in step 60 is preferably performed in a completely vertical direction, directly against the force of gravity.

At the start of the vertically upward extrusion process, a metal rod or other inert surface makes contact with the POF cores 1300 exiting spinneret pins 800, and lifts the POF cores 1300 up and into grooves in first take-up roll 1200. The POF cores 1300 are then passed through the rest of the system in the same manner as is commonly done for horizontal or vertically downward extrusion processes.

At step 70, the POF cores 1300 are cooled in a controlled manner. In one embodiment, the POF cores 1300 are cooled in a dual cooling zone system.

Stage 1 quench unit 1000 is located parallel to spinneret pins 800 and typically 0.1 to 2 inches away from the POF cores 1300 exiting spinneret pins 800. Stage 1 quench unit 1000 gradually cools the POF cores 1300 by blowing air over the fibers. Stage 1 quench unit 1000 is typically operated between 0 and 130° C., with 100° C. being preferred. Fans in stage 1 quench unit 1000 typically operate between 0 and 1750 RPM (0.058 PSI), with 1200 RPM (0.027 PSI) being preferred. Stage 2 quench unit 1100 is also capable of operating between 0 and 130° C., but typically operates at lower temperature than Stage 1 quench unit 1000, with temperatures between 0 and 20° C. being preferred. Fans in stage 2 quench unit 1100 typically operate between 0 and 1750 RPM, with 1000 RPM (0.018 PSI) being preferred.

At step 80, cladding is applied to POF core 1300. Exemplary components for applying the POF cladding layer are shown in FIG. 2. An extruder screw and barrel assembly (not shown in FIG. 2) is coupled to crosshead extruder 1500. The extruder screw and barrel assembly for the cladding can use the same design as that for extruder screw/barrel assembly 300. A preferred cladding material is a fluoropolymer supplied by Dyneon LLC and designated as THV-220G.

Table 1 gives exemplary process parameters for cladding previously extruded POF core 1300 using the components shown in FIG. 2. In Table 1, Zones 1-4 refer to four separate heating zones along the longitudinal length of the extruder barrel. These four zones progressively heat the cladding polymer pellets and produce uniformly distributed cladding extrudate at crosshead extruder 1500.

TABLE 1
Cladding Extrusion Conditions and Results

| | |
|---|---|
| Extruder Zone | Zone 1 (210° C.), Zone 2 (241° C.), Zone 3 |
| Temperatures | (245° C.), Zone 4 (250° C.) |
| Extruder Pressure | 868 PSI |
| Primary Quench | 2.7° C.; 1.22 in H₂O air flow pressure |
| Turning Roll | 4.3 MPM |
| Upper S Wrap | 4.9 MPM |
| Secondary Quench | 23.5° C.; 0.32 in H₂0 air flow pressure |
| POF Overall Diameter | Avg: 1,116.5 micron, StDev: 15.9 |
| Roundness | Avg: 10.4 micron StDev: 2.6 |
| Cladding thickness | 162 micron |

Crosshead extruder 1500 is comprised of an adjustable nozzle system with flow controls to allow for the application of cladding to POF core 1300 as a continuous process occurring as a second in-line step. The nozzle system utilized in this process was internally fabricated, but numerous commercial application crossheads are available. Examples of typical commercially available extrusion crossheads are those offered by Genca Corporation of Clearwater, Fla. (www.genca.com).

After the cladding is applied, clad POF 1600 is cooled rapidly by a primary quench (e.g., at 2.7° C.) using quench unit 1700. The primary quench dissipates heat in the cladding material quickly to minimize heating of POF core 1300, thereby minimizing changes in the optical properties at the POF core-cladding interface. Quench unit 1700 then performs a secondary quench (e.g., at 23.5° C.).

At step 90, the uniformity of the POF cross section is measured. In one embodiment, the measurement is done using laser micrometer 1900. An exemplary laser micrometer 1900 is a Beta LaserMike diameter gauge (Beta LaserMike, 8001 Technology Blvd., Dayton, Ohio 45424, www.betalasermike.com). As is well known to those of skill in the art, to increase the uniformity of the POF cross section, laser micrometer 1900 can optionally be part of an on-line automatic feedback control system.

As shown in FIG. 2, at step 95, clad POF 1600 is fed via turning roll 1800 to an S wrap system in winding unit 2000 and wound onto POF spool 2400.

In addition to the steps described above, after vertically upward extrusion, the POF can be drawn by a variety of different methods, including without limitation: (1) spin drawing plus cladding; (2) spin drawing plus solid-state drawing; (3) co-extruding of core and cladding plus spin drawing; (4) spin drawing co-extruded POF plus solid-state drawing; and (5) one-step co-extruding of core and cladding plus continuous incremental drawing.

In spin drawing plus cladding, the POF cores 1300 are drawn immediately after extrusion from the spinneret pins 800 and a compatible cladding is applied as POF cores 1300 solidify. This drawing method typically provides excellent interfacial adherence between POF core 1300 and the cladding material, with no phase separation between the cladding and POF core 1300. This drawing method also typically produces low molecular orientation in the POF, moderate fiber strength, and moderate cladding uniformity.

In spin drawing plus solid-state drawing, the POF cores 1300 are drawn immediately after extrusion from the spinneret pins 800 and wound onto a spool. These POF cores 1300 are then unwound from the spool in a secondary process and drawn in the solid state with a large draw ratio. Cladding material is then applied after solid-state drawing. This drawing method typically provides POF core 1300 with very high molecular orientation and excellent interfacial adherence between POF core 1300 and cladding material, with no phase separation between the cladding and POF core 1300. This multi-step drawing process typically produces moderate cladding uniformity.

In co-extruding of core and cladding plus spin drawing, the POF cores 1300 are co-extruded with the cladding material and then drawn immediately after co-extrusion and wound onto a spool. This drawing method typically provides excellent cladding uniformity with no phase separation between the cladding and POF core 1300. This drawing method typically produces POF with low molecular orientation and moderate strength.

In spin drawing co-extruded POF plus solid-state drawing, the POF cores 1300 are co-extruded with the cladding material and then drawn immediately after co-extrusion and wound onto a spool. The POFs are then unwound from the spool in a secondary process and drawn in the solid state with a large draw ratio. This drawing method typically produces highly oriented POF with high strength and excellent cladding uniformity. However, phase separation between the core and cladding during the solid-state drawing step may produce defects in the POF.

In one-step co-extruding of core and cladding plus continuous incremental drawing, spin drawn co-extruded POF are continuously drawn by increasing the linear speed of each roll that the POF passes over. For example, the linear speed of roll 2100 will be greater than the linear speed of roll 1800, thereby drawing the POF between roll 2100 and roll 1800. This incremental drawing process can be repeated between additional rolls and under different drawing temperatures. This drawing procedure results in a large draw ratio and high molecular orientation without a separate solid-state drawing step. This drawing method typically produces high strength POF with excellent physical and environmental stability, excellent cross section uniformity, and no phase separation between the cladding and POF core 1300.

Uniform, circular POF cores with a wide range of target diameters (e.g., 250, 500, 750, 1000, 1500 and 2000 microns) were produced using vertically upward extrusion. Each POF core 1300 was continuously extruded without cladding and was produced using ATOFINA resin V825NA according to the method described above (with step 80 omitted).

Table 2 presents core diameter and roundness data for each target diameter. Roundness refers to the difference in core diameter measured by laser micrometer 1900 in two orthogonal directions at a given POF core cross section. Table 2 also presents core diameter and roundness data for corresponding samples produced using vertically downward extrusion. As shown in Table 2, the samples made with vertically upward extrusion had much less variation in their core diameter (i.e., smaller standard deviation in core diameter) and better roundness values (i.e., smaller average roundness) than the corresponding samples made with vertically downward extrusion.

For samples produced using vertically upward extrusion, the standard deviation in core diameter was less than one percent of the average core diameter (except for the 250 micron diameter samples, where it was 1.4%). On the other hand, for the corresponding samples produced using vertically downward extrusion, the standard deviation in core diameter was between 2.4% and 10.4% of the average core diameter.

TABLE 2

| | Vertically | | Vertically | |
|---|---|---|---|---|
| | Upward Extrusion | | Downward Extrusion | |
| Target | | | | |
| Core | Core Diameter | Roundness | Core Diameter | Roundness |
| Diameter | (micron) | (micron) | (micron) | (micron) |
| 250 | Avg: 249.75 | Avg: 2.05 | Avg: 248.15 | Avg: 4.38 |
| micron | StDev: 3.4 | StDev: 0.63 | StDev: 25.93 | StDev: 2.05 |
| | N = 8,520 | N = 8,520 | N = 8,504 | N = 8,504 |
| | Samples | Samples | Samples | Samples |
| 500 | Avg: 499.78 | Avg: 2.3 | Avg: 499.48 | Avg: 3.12 |
| micron | StDev: 3.53 | StDev: 0.65 | StDev: 30.48 | StDev: 1.55 |
| | N = 9,004 | N = 9,004 | N = 8,509 | N = 8,509 |
| | Samples | Samples | Samples | Samples |
| 750 | Avg: 749.18 | Avg: 1.73 | Avg: 748.95 | Avg: 3.32 |
| micron | StDev: 3.88 | StDev: 0.60 | StDev: 27.08 | StDev: 1.02 |
| | N = 9,385 | N = 9,385 | N = 9,005 | N = 9,005 |
| | Samples | Samples | Samples | Samples |
| 1,000 | Avg: 999.28 | Avg: 3.10 | Avg: 1,000.92 | Avg: 3.50 |
| micron | StDev: 3.63 | StDev: 0.78 | StDev: 24.18 | StDev:0.95 |
| | N = 9,484 | N = 9,484 | N = 8,686 | N = 8,686 |
| | Samples | Samples | Samples | Samples |
| 1,500 | Avg: 1,498.85 | Avg: 5.43 | Avg: 1,494.85 | Avg: 5.95 |
| micron | StDev: 3.80 | StDev: 1.98 | StDev: 38.85 | StDev: 1.85 |
| | N = 9,329 | N = 9,329 | N = 8,752 | N = 8,752 |
| | Samples | Samples | Samples | Samples |
| 2,000 | Avg: 1,999.53 | Avg: 1.33 | Avg: 1,906.32 | Avg: 1.38 |
| micron | StDev: 4.18 | StDev: 1.90 | StDev: 55.48 | StDev: 3.80 |
| | N = 9,139 | N = 9,139 | N = 8,053 | N = 8,053 |
| | Samples | Samples | Samples | Samples |

The various embodiments described above should be considered as merely illustrative of the present invention. They are not intended to be exhaustive or to limit the invention to the forms disclosed. Those skilled in the art will readily appreciate that still other variations and modifications may be practiced without departing from the general spirit of the invention set forth herein. Therefore, it is intended that the present invention be defined by the claims that follow.

What is claimed is:

1. A method for continuously making a plastic optical fiber core with a uniform cross section, comprising:
drying a polymeric starting material;
melting said polymeric starting material in a continuous screw extruder;
stabilizing the screw speed of said extruder;
passing the melted polymeric starting material through a high flow, low restriction channel;
extruding the melted polymeric starting material in a substantially vertical upward direction to form a plastic optical fiber core with a uniform cross section;
controlling the temperature of the melted polymeric starting material during extrusion; and
cooling the plastic optical fiber core in a controlled manner.

2. The method of claim 1, wherein said uniform cross section is a circular cross section.

3. A method for continuously making a plastic optical fiber core with a uniform cross section, comprising:
melting a polymeric starting material in a continuous screw extruder and
extruding the melted polymeric starting material in a substantially vertical upward direction to form a plastic optical fiber core with a uniform cross section.

4. The method of claim 3, wherein said uniform cross section is a circular cross section.

5. The method of claim 4, wherein the standard deviation in plastic optical fiber core diameter is less than two percent of the average plastic optical fiber core diameter.

6. The method of claim 3, further comprising the step of drying said polymeric starting material.

7. The method of claim 3, further comprising the step of venting said screw extruder.

8. The method of claim 3, further comprising the step of stabilizing the screw speed of said extruder.

9. The method of claim 3, further comprising the step of stabilizing the pressure of said melted polymeric starting material in said extruder.

10. The method of claim 3, further comprising the step of controlling the temperature of said melted polymeric material during extrusion.

11. The method of claim 3, further comprising the step of passing the melted polymeric starting material through a high flow, low restriction channel.

12. The method of claim 3, further comprising the step of cooling the plastic optical fiber core in a controlled manner.

13. The method of claim 3, further comprising the step of drawing the plastic optical fiber core.

14. A method for continuously making a plastic optical fiber with a uniform core cross section, comprising:
melting a polymeric starting material in a continuous screw extruder;
extruding the melted polymeric starting material in a substantially vertical upward direction to form a plastic optical fiber core with a uniform cross section; and
applying a cladding layer to said plastic optical fiber core.

15. The method of claim 14, wherein said applying step occurs at the same time as said extruding step.

16. The method of claim 14, wherein said applying step occurs after said extruding step.

17. A system for continuously making a plastic optical fiber core with a uniform cross section, comprising:
one or more screw extruders and
one or more extrusion blocks,
wherein said one or more screw extruders are used to continuously melt a polymeric starting material and
wherein said one or more extrusion blocks extrude the melted polymeric starting material in a substantially vertical upward direction to form a plastic optical fiber core with a uniform cross section.

18. The system of claim 17, wherein said uniform cross section is a circular cross section.
